(19) United States
(12) Patent Application Publication
(10) Pub. No.: US 2010/0290830 A1
(43) Pub. Date: Nov. 18, 2010

(54) Connector for Safety Gates

(76) Inventor: Shu-Chen Cheng, Tamshui Chen (TW)

Correspondence Address: The Weintraub Group, P.L.C., 28580 Orchard Lake Road, Suite 140, Farmington Hills, MI, 48334, US

(21) Appl. No.: 12/774,782

(22) Filed: May 6, 2010

(30) Foreign Application Priority Data
May 13, 2009 (CN) 200920155502.6

(51) Int. Cl. F16B 7/04

(52) U.S. Cl. 403/290; 403/289

(57) ABSTRACT

A connector for safety gates has a body being hollow and having an inner space, a baffle, a securing segment and a slit. The baffle is formed in the body to define the inner space into a first holding channel and a second holding channel formed through the body and parallel with each other. The securing segment is formed on the bottom. The slit is formed through the securing segment and the bottom of the body and communicates with the second holding channel to make the second holding channel openable and to divide the securing segment into a first part corresponding to the first holding channel and a second part corresponding to the second holding channel.

### BACKGROUND OF THE INVENTION

1. Field of the Invention

The present invention relates to a connector, and more particularly to a connector that can connect two safety gates together conveniently.

2. Description of Related Art

A safety gate is always mounted in a passage to kitchen or stair to keep children or pets from being injured or from ruining furniture or household objects. However, a conventional safety gate has a fixed width that cannot be applied to all of the passages in houses, a gate connector is provided to combine two gates together to fit with different needs.

A conventional gate connector comprises two holding tabs combined with each other to define a holding space for holding lateral rods of two safety gates inside. With multiple fasteners being mounted through the tabs and into the lateral rods, the safety gates are combined with each other with the gate connector.

However, to combine two gates with the conventional gate connector, a user has to hold the holding tabs with the safety gates with one hand and rotate the fasteners with the other. Because the safety gates are held with a single hand of the user, the alignment between the safety gates is unstable. Therefore, the combining process of the conventional gate connector is difficult and laborious.

To overcome the shortcomings, the present invention tends to provide a connector for safety gates to mitigate or obviate the aforementioned problems.

### SUMMARY OF THE INVENTION

The main objective of the invention is to provide a connector that can connect two safety gates together conveniently.

The connector has a body being hollow and having an inner space, a baffle, a securing segment and a slit. The baffle is formed in the body to define the inner space into a first holding channel and a second holding channel formed through the body and parallel with each other. The securing segment is formed on the bottom. The slit is formed through the securing segment and the bottom of the body and communicates with the second holding channel to make the second holding channel openable and to divide the securing segment into a first part corresponding to the first holding channel and a second part corresponding to the second holding channel.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the connector in accordance with the present invention;

FIG. 2 is a side view in partial section of the connector in FIG. 1;

FIG. 3 is an operational side view in partial section of the connector in FIG. 1 showing the second holding channel being opened; and

FIG. 4 is a perspective view of two safety gates combined with each other with two connectors in FIG. 1.

### DETAILED DESCRIPTION OF PREFERRED EMBODIMENT

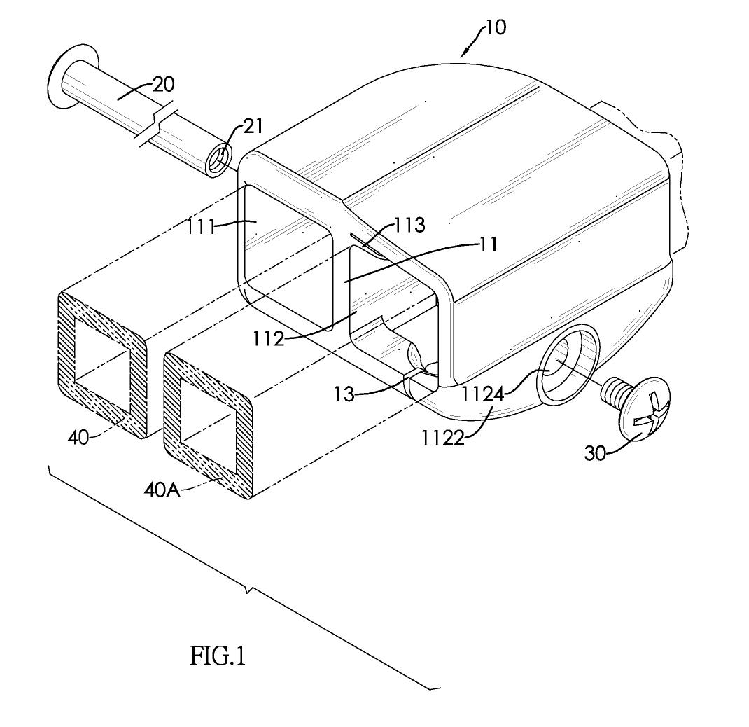

With reference to FIGS. 1 and 3, a connector for safety gates in accordance with the present invention comprises a body 10 and at least one fastener. The body 10 is hollow, may be rubber or plastic and has a top, a bottom, an inner space, a baffle 11, a securing segment 12 and a slit 13. The baffle 11 is formed in the body 10 to define the inner space into a first holding channel 111 and a second holding channel 112 formed through the body 10 and parallel with each other. Additionally, the baffle 11 has a holding tab 113 formed laterally on the baffle 11 at a position adjacent to the top of the body 10 and protruding into the second holding channel 112.

The securing segment 12 is formed on the bottom and has at least one through hole 121 defined through the securing segment 12 along a direction perpendicular to that of the holding channels 111,112.

The slit 13 is formed through the securing segment 12 and the bottom of the body 10 and communicates with the second holding channel 112. With the arrangement of the slit 13, the second holding channel 112 is openable and the securing segment 12 is divided into a first part 122 corresponding to the first holding channel 111 and a second part 124 corresponding to the second holding channel 112. Each through hole 121 has a first segment 1211 and a second segment 1212 divided by the slit 13. The first segment 1211 is defined through the first part 122 of the securing segment 12. The second segment 1212 is defined through the second part 124 of the securing segment 12 and aligning with the first segment 1211.

The at least one fastener is mounted respectively through the at least one through hole 121 to securely hold the first and second parts 122,124 of the securing segment 12 together. Each fastener comprises a female element 20 and a male element 30. The female element 20 is mounted through the first segment 1211 and into the second segment 1212 of a corresponding through hole 121 and has a threaded hole 21. The male element 30 is mounted into the second segment 1212 and is screwed into the threaded hole 21 in the female element 20.

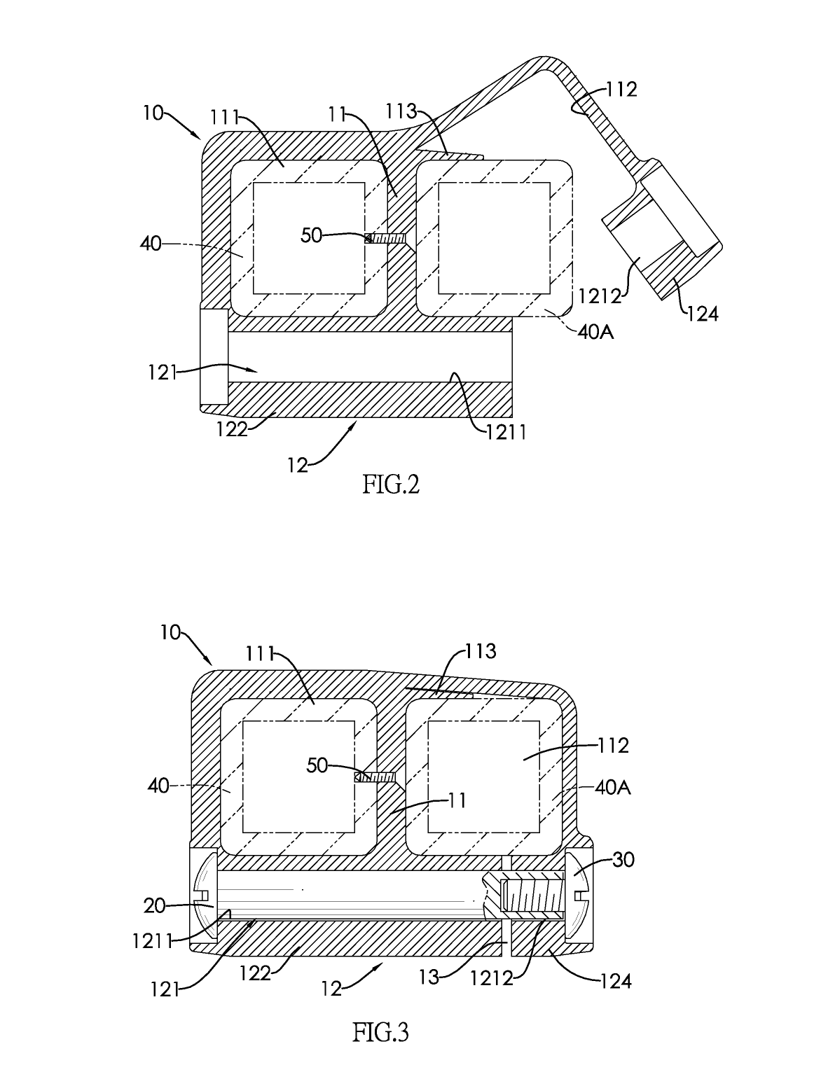

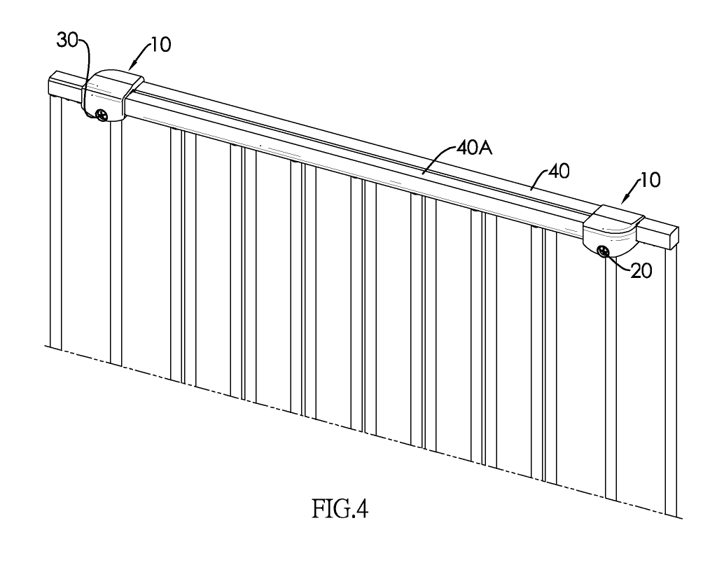

With further reference to FIGS. 2 and 4, to combine two safety gates 40,40A, a lateral rod of a first safety gate 40 is mounted through the first holding channel 111 of a first connector to hold the body 10 of the first connector on the lateral rod. At this time, at least one screw 50 is mounted through the baffle 11 and is crewed into the lateral rod to improve the combination between the body 10 and the lateral rod. Then, the second holding channel 112 of the first connector is opened to hold a later rod of a second safety gate 40A inside. With the arrangement of the holding tab 113, the later rod of the second safety gate 40A is held securely in the second holding channel 112, so to hold the second safety gate 40A with hands of a user is unnecessary. After the second holding channel 112 is released, the second holding channel 112 can be closed automatically. The at least one fastener is mounted into the through hole 121 to securely hold the first and second parts 122,124 of the securing segment 12 together. Alternatively, a second connector is mounted previously on the second safety gate 40A with the first holding channel 111 of the second connector, and is then connected with the first safety gate 40 with the openable second holding channel 112. Accordingly, the safety gates 40,40A are combined with each other with the connectors to form a combined gate with a desired width. Therefore, to combine two safety gates 40,40A with the connectors in accordance with the present invention is easy and convenient by a single person. Additionally, because the body 10 is formed as a single part, the structure of the connector can be efficiently simplified, the costing for manufacturing the connector can also be efficiently reduced.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connector for safety gates comprising:
a body being hollow and having
a bottom;
an inner space;
a baffle formed in the body to define the inner space into a first holding channel and a second holding channel formed through the body and parallel with each other;
a securing segment formed on the bottom; and
a slit formed through the securing segment and the bottom of the body and communicating with the second holding channel to make the second holding channel openable and to divide the securing segment into a first part corresponding to the first holding channel and a second part corresponding to the second holding channel.

2. The connector as claimed in claim 1, wherein the securing segment has at least one through hole defined through the securing segment along a direction perpendicular to that of the holding channels;
each one of the at least one through hole has
a first segment defined through the first part of the securing segment; and
a second segment defined through the second part of the securing segment and aligning with the first segment; and
at least one fastener is mounted respectively through the at least one through hole to securely hold the first and second parts of the securing segment together.

3. The connector as claimed in claim 2, wherein each one of the at least one fastener comprises
a female element mounted through the first segment and into the second segment of a corresponding through hole and having a threaded hole; and
a male element mounted into the second segment and screwed into the threaded hole in the female element.

4. The connector as claimed in claim 3, wherein the baffle has a holding tab formed laterally on the baffle at a position adjacent to the top of the body and protruding into the second holding channel.

5. The connector as claimed in claim 2, wherein the baffle has a holding tab formed laterally on the baffle at a position adjacent to the top of the body and protruding into the second holding channel.

6. The connector as claimed in claim 1, wherein the baffle has a holding tab formed laterally on the baffle at a position adjacent to the top of the body and protruding into the second holding channel.
